(19) United States
(12) Patent Application Publication
(10) Pub. No.: US 2018/0305984 A1
(43) Pub. Date: Oct. 25, 2018

(54) SELF-LIMITING C-RING SYSTEM AND METHOD

(71) Applicant: Vetco Gray Inc., Houston, TX (US)

(72) Inventors: Baozhi Zhu, Houston, TX (US); Luke Andrew McElmurry, Houston, TX (US); Daniel Barnhart, Houston, TX (US); David L. Ford, Houston, TX (US); Gregory Matthew Dunn, Houston, TX (US)

(73) Assignee: Vetco Gray Inc., Houston, TX (US)

(21) Appl. No.: 15/496,949

(22) Filed: Apr. 25, 2017

(51) Int. Cl. E21B 17/04; F16L 21/06; B23H 9/00

(52) U.S. Cl. CPC E21B 17/04; B23H 9/00; F16L 21/06

(57) ABSTRACT

Embodiments of the present disclosure include an apparatus for forming a tubular fitting includes an annular body having an axial height and radial thickness. The apparatus also includes an inner arm forming at least a portion of the annular body, the inner arm positioned at a first end of the annular body with an inner arm thickness that is less than the radial thickness. The apparatus includes an outer arm forming at least a portion of the annular body, the outer arm positioned at a second end of the annular body with an outer arm thickness that is less than the radial thickness. Also, the apparatus includes one or more self-limiting features that control movement of the inner arm and the outer arm relative to one another.

### BACKGROUND

### 1. Field of the Invention

The present disclosure relates to sealing and/or locking devices. More particularly, the present disclosure relates to systems and methods of self-limiting c-rings.

### 2. Description of Related Art

Sealing and/or locking devices are used in many industrial applications to secure components and/or limit fluid (e.g., liquid, gas, a combination of the two, etc.) ingress or egress between mechanical connections. In certain applications c-rings are arranged in grooves and include a pair of free ends to enable expansion and contraction of the c-ring, for example due to temperature and/or pressure changes in the system. For example, in oil and gas exploration, tubular connections may expand and contract due to temperature and/or pressure changes. Or, c-rings may be used as retention devices. Because c-rings have an open end, they are susceptible to torsional forces (e.g., twisting), axial movement along a component, over-expansion, and over-collapse. It is now recognized that improved c-rings are desired.

### SUMMARY

Applicants recognized the problems noted above herein and conceived and developed embodiments of systems and methods, according to the present disclosure, for self-limiting c-rings.

In an embodiment an apparatus for forming a tubular fitting includes an annular body having an axial height and radial thickness. The apparatus also includes an inner arm forming at least a portion of the annular body, the inner arm positioned at a first end of the annular body with an inner arm thickness that is less than the radial thickness. The apparatus includes an outer arm forming at least a portion of the annular body, the outer arm positioned at a second end of the annular body with an outer arm thickness that is less than the radial thickness. Also, the apparatus includes one or more self-limiting features that control movement of the inner arm and the outer arm relative to one another.

In another embodiment a system for forming a coupling between tubulars includes a tubular and a self-limiting c-ring arranged circumferentially about the tubular. The c-ring includes an inner arm forming at least a portion of an annular body of the c-ring, the inner arm being positioned at a first end of the annular body. The c-ring also includes an outer arm forming at least a portion of the annular body, the outer arm being positioned at a second end of the annular body and overlapping the inner arm when the c-ring is in a fully collapsed position. Additionally, the c-ring includes one or more self-limiting features arranged on the annular body to control the movement of the inner arm and the outer arm relative to one another.

In an embodiment a method includes positioning a c-ring in an electrical discharge machine, the c-ring having an axial height and radial thickness. The method also includes removing material from the c-ring such that one or more cuts extends through the axial height of the c-ring. The method further includes removing the c-ring from the electrical discharge machine after the one or more cuts are completed

### BRIEF DESCRIPTION OF DRAWINGS

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

FIG. 1 is a schematic side view of an embodiment of a drilling system, in accordance with embodiments of the present disclosure;

FIG. 2 is a schematic side view of an embodiment of an offshore drilling operation, in accordance with embodiments of the present disclosure;

FIG. 3 is a partial cross-sectional view of an embodiment of a c-ring positioned within a seal and hanger assembly, in accordance with embodiments of the present disclosure;

FIG. 4 is a partial cross-sectional view of an embodiment of a c-ring positioned within a seal and hanger assembly, in accordance with embodiments of the present disclosure;

FIG. 5 is a perspective view of an embodiment of a c-ring, in accordance with embodiments of the present disclosure;

FIG. 6 is a top plan view of the c-ring of FIG. 5, in accordance with embodiments of the present disclosure;

FIG. 7 is a partial detail perspective view of the c-ring of FIG. 5, in accordance with embodiments of the present disclosure;

FIG. 8 is a partial detail perspective view of the c-ring of FIG. 5, in accordance with embodiments of the present disclosure;

FIG. 9A is cross-sectional view of an embodiment of a tongue and groove fitting of the c-ring of FIG. 5, in accordance with embodiments of the present disclosure;

FIG. 9B is cross-sectional view of an embodiment of a tongue and groove fitting of the c-ring of FIG. 5, in accordance with embodiments of the present disclosure;

FIG. 9C is cross-sectional view of an embodiment of a tongue and groove fitting of the c-ring of FIG. 5, in accordance with embodiments of the present disclosure;

FIG. 9D is cross-sectional view of an embodiment of a tongue and groove fitting of the c-ring of FIG. 5, in accordance with embodiments of the present disclosure;

FIG. 10 is a perspective view of an embodiment of the c-ring of FIG. 5 positioned within an annular fitting, in accordance with embodiments of the present disclosure;

FIG. 11 is a perspective view of an embodiment of the c-ring of FIG. 5 with axial retention features, in accordance with embodiments of the present disclosure;

FIG. 12 is a perspective view of an embodiment of a c-ring, in accordance with embodiments of the present disclosure;

FIG. 13 is a partial detail perspective view of the c-ring of FIG. 12, in accordance with embodiments of the present disclosure;

FIG. 14 is a partial detail perspective view of the c-ring of FIG. 12, in accordance with embodiments of the present disclosure;

FIG. 15 is a partial detail perspective view of the c-ring of FIG. 12, in accordance with embodiments of the present disclosure;

FIG. 16 is a perspective view of an embodiment of the c-ring of FIG. 12 arranged about an annular fitting, in accordance with embodiments of the present disclosure;

FIG. 17 is a perspective view of an embodiment of the c-ring of FIG. 12 positioned within an annular fitting, in accordance with embodiments of the present disclosure;

FIG. 18 is a perspective view of an embodiment of the c-ring of FIG. 12 with axial retention features, in accordance with embodiments of the present disclosure;

FIG. 19 is a perspective view of an embodiment of the c-ring of FIG. 12 with axial retention features, in accordance with embodiments of the present disclosure;

FIG. 20 is a partial detail perspective view of the c-ring, in accordance with embodiments of the present disclosure;

FIG. 21 is a partial detail perspective view of the c-ring of FIG. 20, in accordance with embodiments of the present disclosure;

FIG. 22 is a partial detail perspective view of the c-ring of FIG. 20, in accordance with embodiments of the present disclosure;

FIG. 23A is a schematic top plan view of an embodiment of the c-ring, in accordance with embodiments of the present disclosure;

FIG. 23B is a schematic top plan view of an embodiment of the c-ring, in accordance with embodiments of the present disclosure;

FIG. 23C is a schematic top plan view of an embodiment of the c-ring, in accordance with embodiments of the present disclosure;

FIG. 23D is a schematic top plan view of an embodiment of the c-ring, in accordance with embodiments of the present disclosure; and

FIG. 24 is flow chart of an embodiment of a method for forming the c-ring of FIGS. 1 and 12, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions.

Embodiments of the present disclosure include a self-limiting c-ring that is utilized to block over-collapse or over-expansion of the c-ring. For example, in certain embodiments, the c-ring includes an inner stop that abuts an inner edge to block over-collapse of the c-ring. Moreover, in certain embodiments, the c-ring includes an outer stop that abuts an outer edge 156 to block over-collapse of the c-ring. Furthermore, in certain embodiments, the c-ring includes one or more features, such as a tongue and groove fitting or elongated edge, to resist twisting and torsional forces applied to the c-ring. For example, in embodiments where the c-ring has a tongue and groove fitting, torsional forces may be resisted due to the interaction of the tongue with the groove. Additionally, in certain embodiments, the c-ring includes one or more edges to prevent over-expansion of the c-ring. For example, as ends of the c-ring are driven apart due to external forces, the edges may come together and effectively hold the edges in a position to block further expansion of the c-ring. In this manner, the c-ring may be retrievable from a component, for example a downhole drilling tool, and reused in other applications.

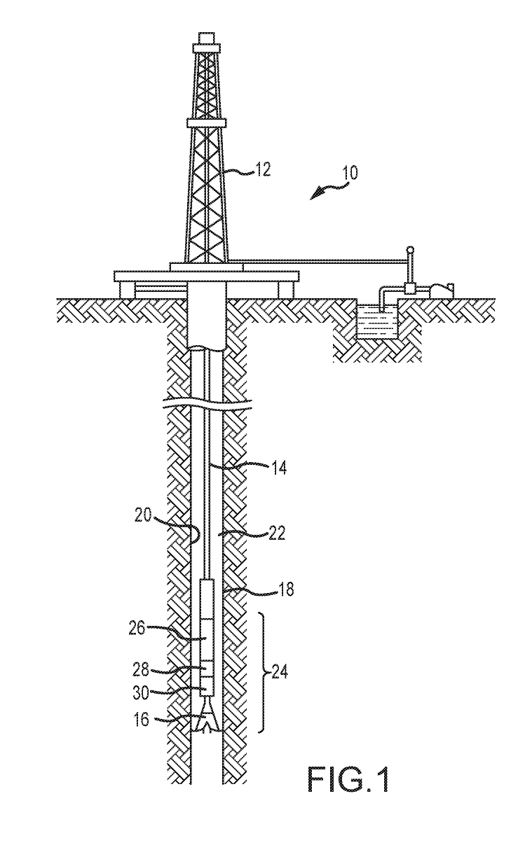

FIG. 1 is a schematic side view of an embodiment of a downhole drilling system 10 (e.g., drilling system) that includes a rig 12 and a drill string 14 coupled to the rig 12. The drill string 14 includes a drill bit 16 at a distal end that may be rotated to engage a formation and form a wellbore 18. As shown, the wellbore 18 includes a borehole sidewall 20 (e.g., sidewall) and an annulus 22 between the wellbore 18 and the drill string 14. Moreover, a bottom hole assembly (BHA) 24 is positioned at the bottom of the wellbore 18. The BHA 24 may include a drill collar 26, stabilizers 28, or the like.

In operation, drilling mud or drilling fluid is pumped through the drill string 14 and out of the drill bit 16. The drilling mud flows into the annulus 22 and removes cuttings from the face of the drill bit 16. Moreover, the drilling mud may cool the drill big 16 during drilling operations and further provide pressure stabilization in the wellbore 18. In the illustrated embodiment, the drilling system 10 includes a logging tool 30 that may conduct downhole loggings operations to obtain various measurements. As will be described in detail below, in certain embodiments, the drill string 14 is formed from one or more tubulars that are mechanically coupled together (e.g., via threads, specialty couplings, or the like). In certain embodiments, c-rings are utilized to form at least a portion of the coupling between tubulars and/or between tubulars and other components of the drilling system 10 or to facilitate formation of those connections.

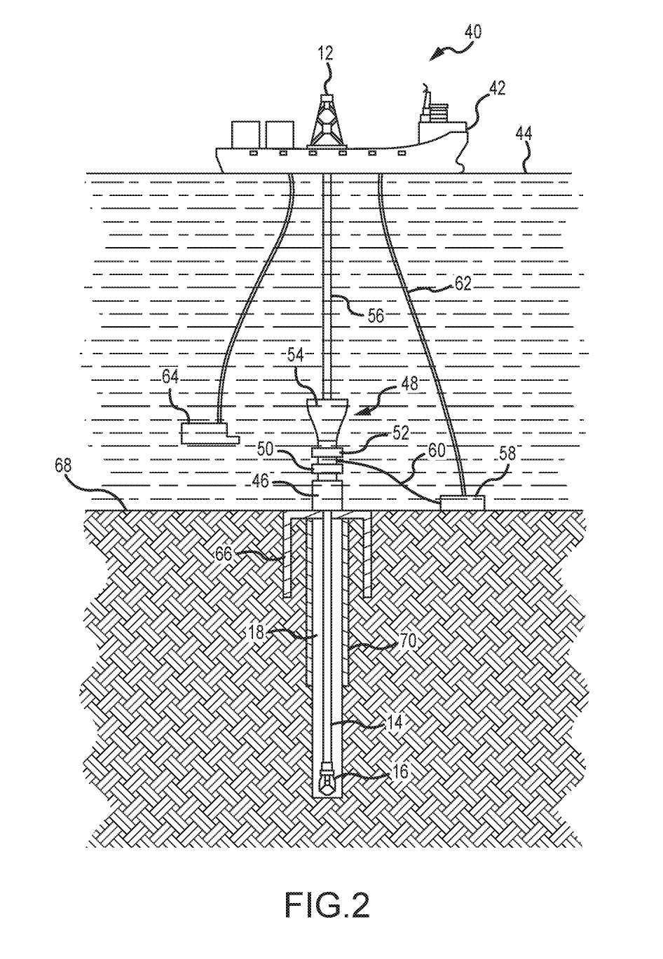

FIG. 2 is a side schematic view of an embodiment of subsea drilling operation 40. The drilling operation includes a vessel 42 floating on the sea surface 44 substantially above a wellbore 18. A wellbore housing 46 sits at the top of the wellbore 18 and is connected to a blowout preventer (BOP) assembly 48, which may include shear rams 50, sealing rams 52, and/or an annular ram 54. One purpose of the BOP assembly 48 is to help control pressure in the wellbore 18. The BOP assembly 48 is connected to the vessel 42 by a riser 56. During drilling operations, the drill string 14 passes from a rig 12 on the vessel 10, through the riser 56, through the BOP assembly 48, through the wellhead housing 46, and into the wellbore 18. The lower end of the drill string 14 is attached to the drill bit 16 that extends the wellbore 18 as the drill string 14 turns. Additional features shown in FIG. 2 include a mud pump 58 with mud lines 60 connecting the mud pump 58 to the BOP assembly 48, and a mud return line 62 connecting the mud pump 34 to the vessel 10. A remotely operated vehicle (ROV) 64 can be used to make adjustments to, repair, or replace equipment as necessary. Although a BOP assembly 48 is shown in the figures, the wellhead housing 46 could be attached to other well equipment as well, including, for example, a tree, a spool, a manifold, or another valve or completion assembly.

One efficient way to start drilling a wellbore 18 is through use of a suction pile 66. Such a procedure is accomplished by attaching the wellhead housing 46 to the top of the suction pile 66 and lowering the suction pile 66 to a sea floor 68. As interior chambers in the suction pile 66 are evacuated, the suction pile 66 is driven into the sea floor 68, as shown in FIG. 2, until the suction pile 66 is substantially submerged in the sea floor 68 and the wellhead housing 46 is positioned at the sea floor 68 so that further drilling can commence. As the wellbore 18 is drilled, the walls of the wellbore are reinforced with concrete casings 70 that provide stability to the wellbore 18 and help to control pressure from the formation.

More specifically, the wellhead assembly, including the wellhead housing 46, is mounted on top of the suction pile 66 and held axially while lowering to the sea floor 68. Depending on the soil conditions, in certain cases, a low pressure housing may be mounted on top of the suction pile while the high pressure housing is installed in a secondary drilling and cementing operation. Once the suction pile 66 and wellhead assembly reaches the seabed, an ROV can shut off the water access hatch and actuate a valve to pump fluid from within the suction pile 66, and enable the suction pile 66 to be installed in the seabed. The wellhead assembly can be installed on a single suction pile 66 or on a frame that consists of multiple suction piles 64. The suction pile(s) 66 can have a greater outer diameter than the cemented casing 70 that extends into the well. As an example the cemented casing 70 can have a maximum outer diameter of 36 inches while a suction pile 66 can have an outer diameter of up to 20 feet, or can include one or more piles with an outer diameter of 20 feet or more. Furthermore, as described above, in certain embodiments, one or more components of the offshore drilling operation 40 may include mechanically coupled connections that may utilize one or more c-rings to accommodate expansion and/or contraction of the components. For example, c-rings may be utilized to form seals between tubular components, such as between the wellhead and a hanger assembly. Furthermore, c-rings may also limit movement and/or tilt of tubulars in the wellbore 18, as will be described in detail below.

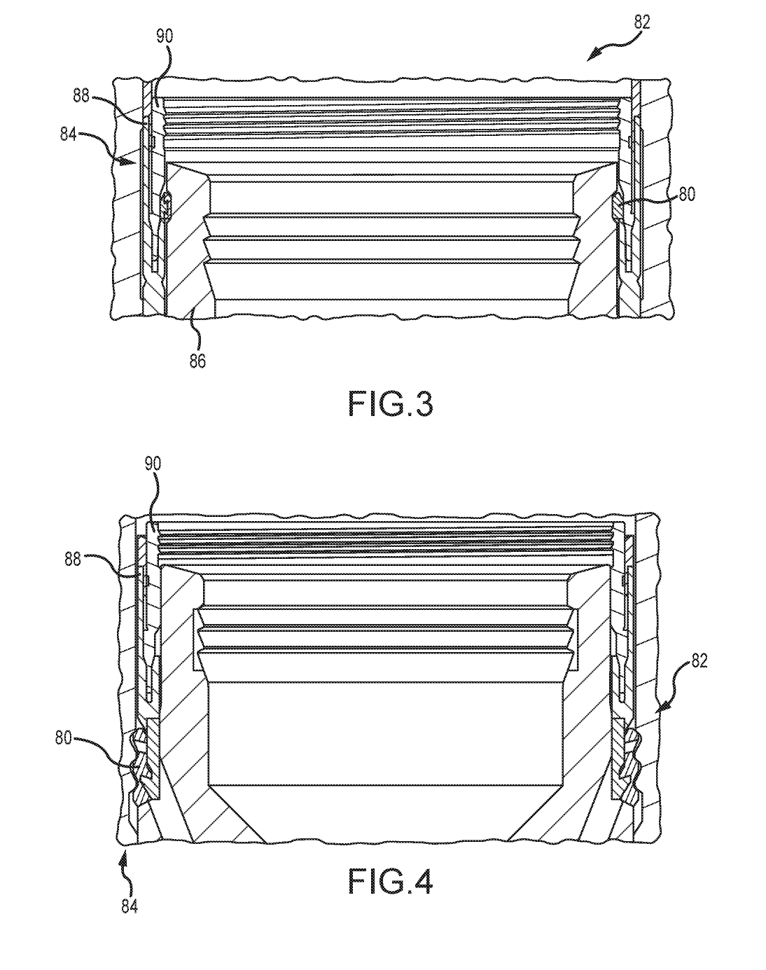

FIG. 3 is a schematic cross-sectional side view of an embodiment of a c-ring 80 arranged within a seal and hanger assembly 82. As will be described below, in certain embodiments, the c-ring 80 may be referred to as a self-limiting c-ring 80. The seal and hanger assembly 82 is a load-bearing device that is generally run through the BOP assembly 48. The seal and hanger assembly 82 is utilized to hang a tubular via a threaded connection. In the illustrated embodiment, the seal and hanger assembly 82 is positioned within a wellhead 84 and includes a tubular 86. Moreover, an annular seal 88 is arranged about the tubular 86 between the wellhead 84 and tubular 86. In the illustrated embodiment, an energizing ring 90 extends into the annular seal 88 to effectively block fluid flow between the wellhead 84 and the seal and hanger assembly 82. It should be appreciated that other components of the seal and hanger assembly 82 will not be discussed in detail, as such components are known by one skilled in the art. As illustrated in FIG. 3, the c-ring 80 is positioned about the tubular 86 and utilized to form a seal between the tubular 86 and the energizing ring 90. Moreover, in certain embodiments, the c-ring 80 may block or restrict tilting movement of the tubular 86 relative to a longitudinal axis. In other words, the c-ring 80 may be used to prevent the tubular 86 from being co-axial with the wellbore 18. Additionally, in certain embodiments, the c-ring 80 locks components in place in the wellbore 18. For example, the c-ring 80 may lock a casing hanger and annulus seal in a wellhead. The c-ring 80 also has applications for other latches, such as running tools and mooring equipment. Furthermore, the c-ring 80 can be used with other downhole equipment. In certain embodiments, the c-ring 80 may be used with location sensors, such as overpull checks. As will be described in detail below, the c-ring 80 may be self-limiting such that expansion and/or collapse of the c-ring 80, for example, due to changes in temperature or pressure, are effectively regulated by the c-ring 80. Moreover, the c-ring 80 may further resist twisting (e.g., torsional forces) such that the c-ring 80 remains in its relative installed position during wellbore operations. By retaining the c-ring 80 in its installed position, the c-ring 80 may be retrieved after drilling operations.

FIG. 4 is a schematic cross-sectional view of an embodiment of the c-ring 80 arranged within the seal and hanger assembly 82. In the illustrated embodiment, the c-ring 80 is positioned between components of the wellhead 84 and the seal and hanger assembly 82. As shown, the c-ring 80 is arranged below the annular seal 88. In certain embodiments, the c-ring 80 may be axially retained by one or more components to be described in detail below. As described above, the c-ring 80 may be utilized to maintain a seal between components, for example, to retain components of the seal and hanger assembly 82 together. Moreover, in certain embodiments, the c-ring 80 may be utilized to restrict fluid flow between components, for example, between the wellhead 84 and the seal and hanger assembly 82. Additionally, as described above, in certain embodiments, the c-ring 80 blocks axial tilting of the seal and hanger assembly 82 within the wellbore 18. For example, the c-ring 80 may expand outwardly and engage the wellhead 84, thereby blocking movement of the seal and hanger assembly 82 relative to the wellhead 84. Furthermore, in certain embodiments, the c-ring 80 is self-limiting such that expansion and/or collapse of the c-ring 80 is controlled. It should be appreciated that while certain aspects of the c-ring 80 are being described with reference to oil and gas exploration equipment, the c-ring 80 has applicability in many other industries and operations. For example, c-rings 80 may be utilized in any industry that uses flexible rings, such as for assembly and retention devices. A non-exhaustive list of industries may include oil fields, refineries, chemical plants, power plants, engines, machinery, transportation, hand tools, and the like.

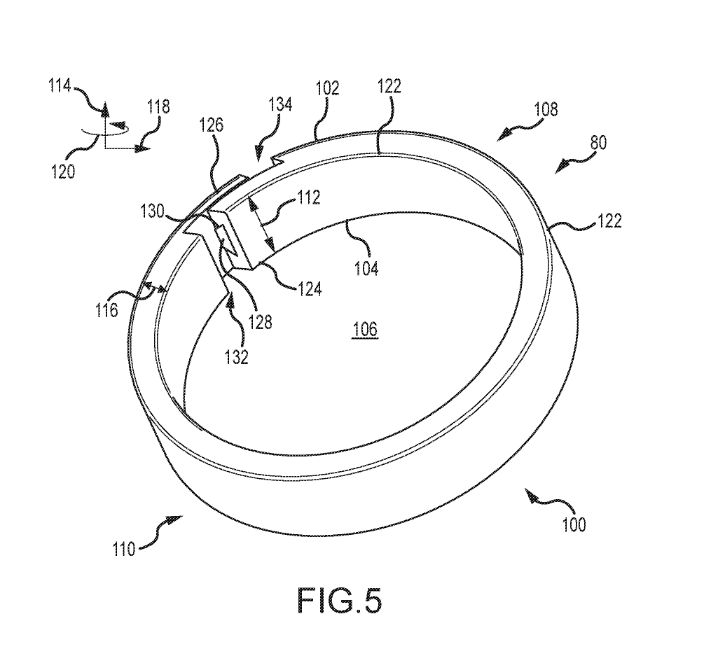

FIG. 5 is a perspective view of an embodiment of the c-ring 80. As described above, the c-ring 80 may be referred to as a self-limiting c-ring 80 because the c-ring 80 includes one or more features, to be described below, that control the expansion and/or collapse of the c-ring 80. In the illustrated embodiment, the c-ring 80 includes a body 100 formed in a generally cylindrical, tubular, and/or annular shape. The body 110, and therefore the c-ring 80, may be formed from rigid materials, such as metals, plastics, or the like. The c-ring 80 includes an outer diameter 102 and an inner diameter 104 with an inner bore 106. In certain embodiments, the outer diameter 102 of the c-ring 80 may include a substantially smooth finish, for example, via a coating or machining. However, in certain embodiments, the outer diameter 102 may include a textured surface or have one or more features, such as load shoulders or retention members, extending off of the outer diameter 102. Furthermore, while the inner diameter 104 of the illustrated c-ring 80 is substantially smooth, in other embodiments, the inner diameter 104 may include a textured surface or the one or more features described above. Moreover, in certain embodiments, the outer diameter 102 or the inner diameter 104 may include one or more resilient sections, such as an elastomer, to facilitate connections between components.

As shown in FIG. 5, the c-ring 80 includes a top 108 and a bottom 110. It should be appreciated that the terms “top” and “bottom” used herein are for illustrative purposes only to simplify discussion of the illustrated embodiments and should be not used to limit the orientation in which the c-ring 80 may be installed. The body 100 of the c-ring 80 extends between the top 108 and the bottom 110 to form an axial height 112 with reference to a longitudinal axis 114. Furthermore, the body 100 of the c-ring 80 extends between the inner diameter 104 and the outer diameter 102 to form a radial thickness 116 with reference to a radial axis 118. Additionally, as described above, the c-ring 80 has a generally cylindrical or tubular shape (e.g., an annular ring) in which the body 100 is revolved about a circumferential axis 120.

In the illustrated embodiment, the c-ring 80 includes bevels 122 on the outer diameter 102 and the inner diameter 104. The bevels 122 may facilitate installation of the c-ring 80. For example, if a mating surface has a corresponding bevel 122 and/or a reduced diameter component, the bevels 122 may be designed to correspond to the mating surface to improve the sealing connection and/or retention by the c-ring 80. However, it should be appreciated that, in certain embodiments, the c-ring 80 may not include the bevels 122. Moreover, in certain embodiments, the bevel 122 may be only on the inner diameter 104 or only on the outer diameter 102. Furthermore, in certain embodiments, the bevel 122 may be only on the top 108 or only on the bottom 110. As shown in FIG. 5, the c-ring 80 includes an inner arm 124 and an outer arm 126. That is, the inner arm 124 is radially closer to the inner diameter 104 than the outer arm 126, which is radially closer to the outer diameter 102. Furthermore, in the illustrated embodiment, the c-ring 80 includes a tongue 128 and groove 130. The tongue 128 is raised from a surface of the outer arm 126 and the groove 130 is formed in the inner arm 124. However, it should be appreciated that, in certain embodiments, the tongue 128 may be raised from a surface of the inner arm 124 and the groove 130 may be formed in the outer arm 126. As will be described below, the tongue 128 fits within the groove 130 and facilitates sliding movement between the inner arm 124 and the outer arm 126 to enable expansion and collapse of the c-ring 80. For example, the c-ring 80 may expand and/or collapse due to pressure changes within the wellbore 18. That is, pressure from the wellbore 18 may act inwardly (e.g., toward the longitudinal axis 114 of the c-ring 80, radially inward, etc.) and thereby drive collapse of the c-ring 80. Additionally, in certain embodiments, as the tubular heats up or pressure within the tubular changes, it may expand and apply an outward force (e.g., away from the longitudinal axis 114 of the c-ring 80, radially outward, etc.) to drive expansion of the c-ring 80. However, other events downhole, or in other applications, may cause expansion of the c-ring 80, such as outside forces, rotational forces, fluid pressure, and the like. Furthermore, as will be described below, collapse of the c-ring 80 enables removal of the c-ring 80 after operations are complete. In certain embodiments, the inner arm 124 and therefore the groove 130 may be referred to as being at a first end 132 of the c-ring 80. Furthermore, the outer arm 126 and therefore the groove 128 may be referred to as being at a second end 134 of the c-ring 80. Additionally, as will be described below, the first and second ends 132, 134 may be said to overlap. That is, the second end 134 and the first end 132 may be arranged such that a portion of the inner arm 124 is at least partially concentric with the outer arm 126.

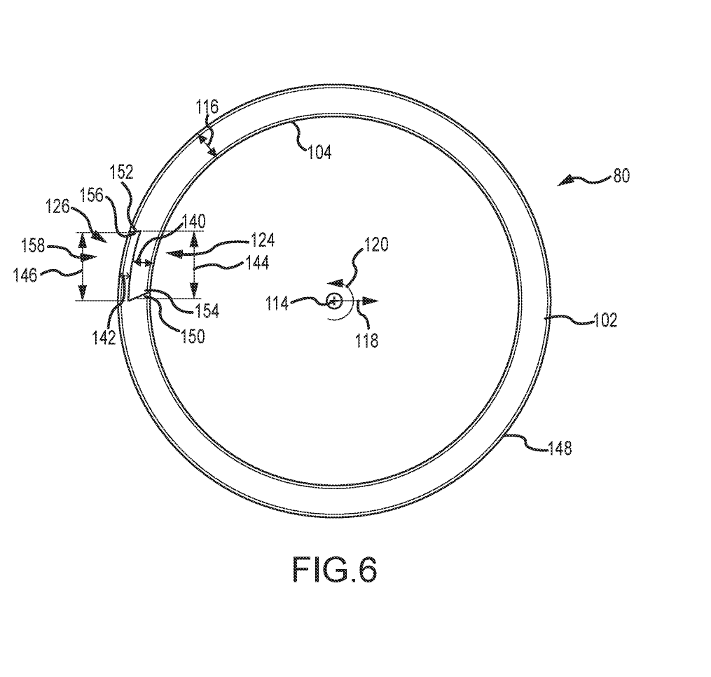

FIG. 6 is a top plan view of an embodiment of the c-ring 80. In the illustrated embodiment, the c-ring 80 is in a fully collapsed position. The c-ring 80 is formed in a substantially annular ring about the circumferential axis 120. The radial thickness 116 is illustrated as extending from the inner diameter 104 to the outer diameter 102. As shown in FIG. 6, the inner arm 124 has an inner arm thickness 140 and the outer arm 126 has an outer arm thickness 142. As will be appreciated, the sum of the inner arm thickness 140 and the outer arm thickness 142 is substantially equal to the radial thickness 116 of the c-ring 80. In the illustrated embodiment, the inner arm thickness 140 is greater than the outer arm thickness 142. However, in certain embodiments, the inner and outer arm thicknesses 140, 142 may be substantially equal. Moreover, in certain embodiments, the outer arm thickness 142 may be greater than the inner arm thickness 140. As will be appreciated, the inner and outer arm thicknesses 140, 142 may be particularly selected based on the anticipated operational pressures and temperatures of the c-ring 80. For example, in certain embodiments, the part having the groove 130 may be thicker than the part having the tongue 128. However, in certain embodiments, the part having the tongue 128 may be thicker than the part having the groove 130. In this manner, different c-rings 80 may be manufactured for different applications. For example, lower pressure applications may have thinner c-rings 80 than high pressure applications.

In the illustrated embodiment, the inner arm 124 has an inner arm length 144 and the outer arm 126 has an outer arm length 146. That is, the respective arm lengths 144, 146 have a circumferential distance (e.g., arc length) relative to the circumferential axis 120. In the illustrated embodiment, the inner arm length 144 is substantially equal to the outer arm length 146. As a result, the c-ring 80 may be positioned in the fully collapsed position illustrated in FIG. 6. However, it should be appreciated that, in other embodiments, the inner arm length 144 may be greater than or less than the outer arm length 146. The respective circumferential distances of the arm lengths 144, 146 are particularly selected based on the application of the c-ring 80. For example, in the illustrated embodiment, the inner and outer arm lengths 144, 146 are approximately equal to 1/15 of a circumference 148 of the c-ring 80. However, in other embodiments, the inner and/or outer arm lengths 144, 146 may be equal to approximately 1/100 of the circumference 148, approximately 1/50 of the circumference 148, approximately 1/25 of the circumference 148, approximately 1/20 of the circumference 148, approximately 1/10 of the circumference 148, approximately ⅕ of the circumference 148, or any other suitable length. Moreover, the respective inner and outer arm lengths 144, 146 may be sized to fall within ranges of the circumference 148, such as between approximately 1/100 of the circumference 148 and approximately 1/50 of the circumference 148, between approximately 1/25 of the circumference 148 and approximately 1/20 of the circumference 148, between approximately 1/10 of the circumference 148 and approximately ⅕ of the circumference 148, or any other suitable range. In this manner, the c-ring 80 may be machined to accommodate a variety of operating temperatures and pressures, as well as ancillary loads that may act on the c-ring 80, such as mooring laches, sensors, retrieval operations, and the like. Furthermore, the c-ring 80 may be formed to work in a variety of industries and equipment of different sizes. For example, the c-ring 80 may be used as a retaining feature in a hand tool that expands and collapses due to rotational forces of a bit or fitting. As used herein, approximately means plus or minus fifteen percent.

As shown in FIG. 6, the inner arm 124 abuts an inner stop 150 and the outer arm 126 abuts an outer stop 152 when the c-ring 80 is fully collapsed. That is, an inner edge 154 of the inner arm 124 is brought into contact with the inner stop 150 when the c-ring 80 is fully collapsed. Moreover, an outer edge 156 of the outer arm 126 is brought into contact with the outer stop 152 when the c-ring 80 is fully collapsed. In certain embodiments, the inner stop 150 and outer stop 152 are arranged on the body 100. However, in other embodiments, the inner stop 150 and the outer stop 152 may be considered to be positioned on the outer arm 126 and the inner arm 124, respectively. As used herein, the features that block collapse and/or expansion of the c-ring 80 may be referred to as self-limiting features 158. As will be described below, in certain embodiments, the inner and outer edges 154, 156 may be back raked to facilitate a closer, more compressed fully collapsed c-ring.

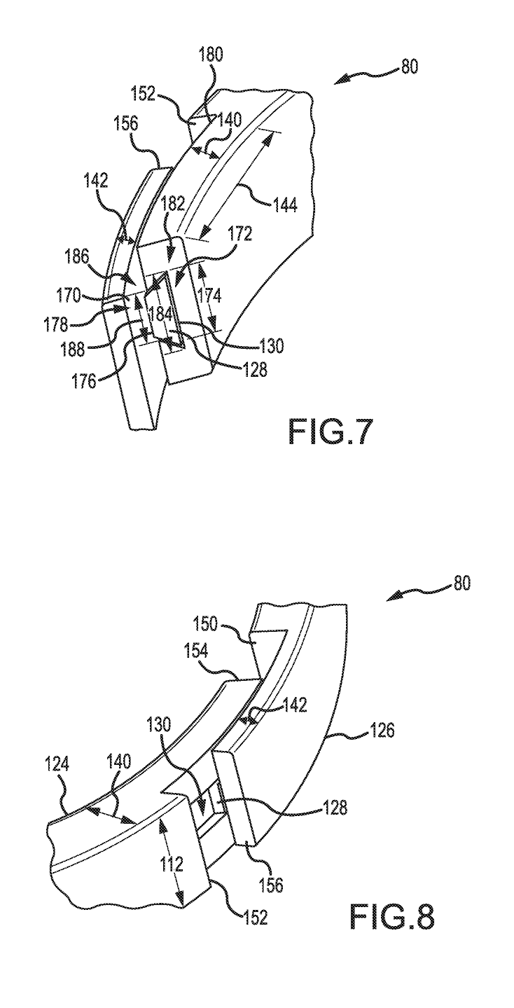

FIG. 7 is a partial perspective view of an embodiment of the tongue 128 of the outer arm 126 interacting with the groove 130 of the inner arm 124. In the illustrated embodiment, the tongue 128 extends radially inwardly from an outer arm surface 170. In other words, the tongue 128 is formed on the outer arm 126 and extends away from the outer arm surface 170 such that the tongue 128 is positioned closer to the longitudinal axis 114 of the c-ring 80 than the outer arm surface 170. In the illustrated embodiment, the tongue 128 has a dove-tail shape. However, in certain embodiments, the tongue 128 may have other shapes, as will be described in detail below. It should be appreciated that an inner portion 172 of the tongue 128 has a greater axial length 174 than an axial length 176 of an outer portion 178. As will be appreciated, the larger inner portion 172 blocks the tongue 128 from being pulled out of the groove 130 by radial or torsional forces, thereby maintaining contact of the c-ring 80 with an associated component. Moreover, as will be described below, the tongue 128 enables the c-ring 80 to resist torsional forces that may deform and/or twist the c-ring 80. In certain embodiments, the forces acting on the c-ring 80 may be from pressure within the wellbore 18. For example, fluid pressure within the tubular may cause expansion of the tubular, thereby generating an outward radial force on the c-ring 80. Moreover, pressure from the formation may cause collapse of the c-ring 80 due to an inward radial force. Additionally, torsional forces may be generated by fluid flow through the tubular and/or the annulus driving the tubular in a longitudinal direction or when the tubular and/or seal and hangar assembly are removed from or inserted into the wellbore 18. Additionally, as described above, in other applications different forces may act on the c-ring 80. For example, in a power plant or refinery external loads acting on devices such as snap rings, quick connects, or safety latches may utilize the expansion and contraction of the c-ring 80.

The tongue 128 is positioned within the groove 130. As shown, the groove 130 is formed radially inwardly relative to an inner arm surface 180. The groove 130 extends radially inward such that the groove 130 is closer to the longitudinal axis 114 than the inner arm surface 180. In the illustrated embodiment, the shape of the groove 130 substantially corresponds to the shape of the tongue 128, thereby facilitating interaction between the tongue 128 and groove 130. In other words, the tongue 128 fits within the groove 130. For example, an inner groove portion 182 has a greater axial length 184 than an axial length 186 of an outer groove portion 188. Accordingly, the tongue 128 and groove 130 may be utilized to limit torsional forces as well as facilitate in the self-limiting properties of the c-ring 80. That is, when torsional forces act on the c-ring 80, the tongue 128 will bear against the groove 130, which will block the inner arm 124 from separating from the outer arm 126.

As illustrated in FIG. 7, the outer arm surface 170 contacts and slides over the inner arm surface 180. In certain embodiments, the respective surfaces 170, 180 may be coated, for example, with a fluoropolymer coating to reduce friction and/or improve wear resistance. However, it should be appreciated that other coatings may be used, such as nylon, high-density polyethylene, polytetrafluoroethylene, or the like. Moreover, in certain embodiments, lubricating fluids such as oils, greases, and the like or other dry lubricants may be utilized to facilitate sliding between the outer arm 126 and the inner arm 124 by reducing friction and thereby increasing the life cycle of the c-ring 80.

FIG. 8 is a partial perspective view of the groove 130 formed in the inner arm 124 interacting with the tongue 128 formed on the outer arm 126. As shown, the groove 130 extends radially inwardly toward the longitudinal axis 114. In other words, the groove 130 extends into the inner arm thickness 140. In the illustrated embodiment, the groove 130 is substantially centered relative to the axial height 112 of the c-ring 80. However, in other embodiments, the groove 130 may not be centered. As described above, in the illustrated embodiment, the groove 130 receives the tongue 128 such that separation of the inner arm 124 and outer arm 126 is blocked. That is, torsional forces are resisted to substantially prevent the c-ring 80 from twisting.

In the illustrated embodiment, the c-ring 80 is between a fully collapsed position and a fully expanded position. In operation, as the c-ring 80 contracts, for example, due to external forces, the inner edge 154 moves toward the inner stop 150. As described above, the inner edge 154 is back raked, and in certain embodiments, so is the inner stop 150, thereby facilitating a closer, tighter connection when the c-ring is fully collapsed. Furthermore, the outer stop 152 contacts the outer edge 156, where one or both may also be back raked, thereby facilitating a tight, compressive fit of the c-ring 80.

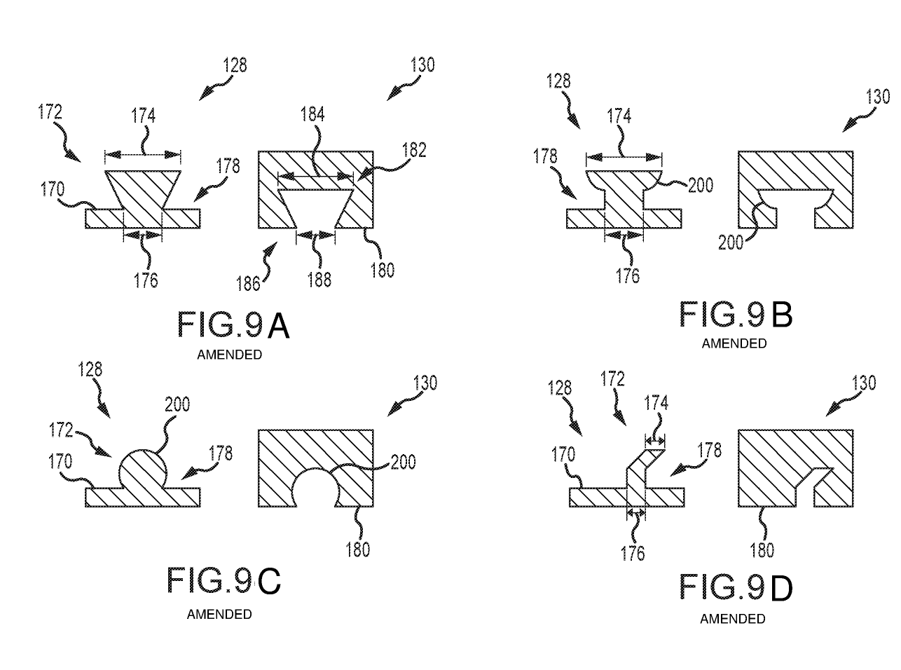

FIG. 9 is a schematic side view of embodiments of shapes for the tongue 128 and groove 130. For example, the embodiment illustrated in FIG. 9a includes the dove tail shape tongue 128 and corresponding groove 130. As described above, the axial length of the inner portion 174 is greater than the axial length of the outer portion 176, thereby blocking separation between the inner arm 124 and the outer arm 126. That is, the inner portion 172 of the tongue 128 is wider (relative to the plane of the page) than the outer portion 178. In this manner, radial separation of the inner arm 124 and the outer arm 126 is substantially blocked, thereby maintaining the compressive force of the c-ring 80.

In the embodiment illustrated in FIG. 9b, the tongue 128 includes curved edges 200 to efficiently transmit forces applied to the tongue 128 and the groove 130. Moreover, as shown, the groove 130 includes corresponding curved edges 200 in order to receive the tongue 128. In the illustrated embodiment, the tongue 128 is substantially symmetrical, however, in other embodiments, as will be illustrated below, the tongue 128, and also the groove 130, need not be symmetrical. In the embodiment illustrated in FIG. 9b, the axial length 174 of the inner portion 172 is larger than the axial length 176 of the outer portion 178, to thereby block separation of the inner arm 124 and the outer arm 126. Moreover, as described above, torsional forces are resisted by the tongue 128 bearing against the sides of the groove 130.

FIG. 9c illustrates an embodiment of the tongue 128 having a substantially circular shape, with the groove 130 having a corresponding substantially circular shape. As illustrated, the tongue 128 includes the curved edges 200 to mate with corresponding curved edges 200 in the groove 130. As a result, the tongue 128 can fit into the groove 130 to resist torsional forces on the c-ring 80 and also to prevent separation of the inner arm 124 and the outer arm 126. FIG. 9d is an embodiment of the tongue 128 that is not symmetrical. Moreover, in the illustrated embodiment, the axial length 174 of the inner portion 178 is substantially the same as the axial length 176 of the outer portion 178. However, because the inner portion 172 is offset from the outer portion 178, separation of the inner arm 124 and the outer arm 126 is still blocked because the tongue 128 will bear against the corresponding groove 130 when outwardly directed radial forces are applied to the c-ring 80. It should be appreciated that the embodiments illustrated in FIG. 9 are examples of tongue 128 and groove 130 fittings and one or more features of each of the embodiments may be incorporated into the other embodiments. For example, the embodiment in FIG. 9b may not be symmetrical. Moreover, the embodiment shown in FIG. 9a may include one or more curved edges 200. In this manner, the tongue 128 and groove 130 fittings may be particularly designed for ease in manufacturing or anticipated load conditions.

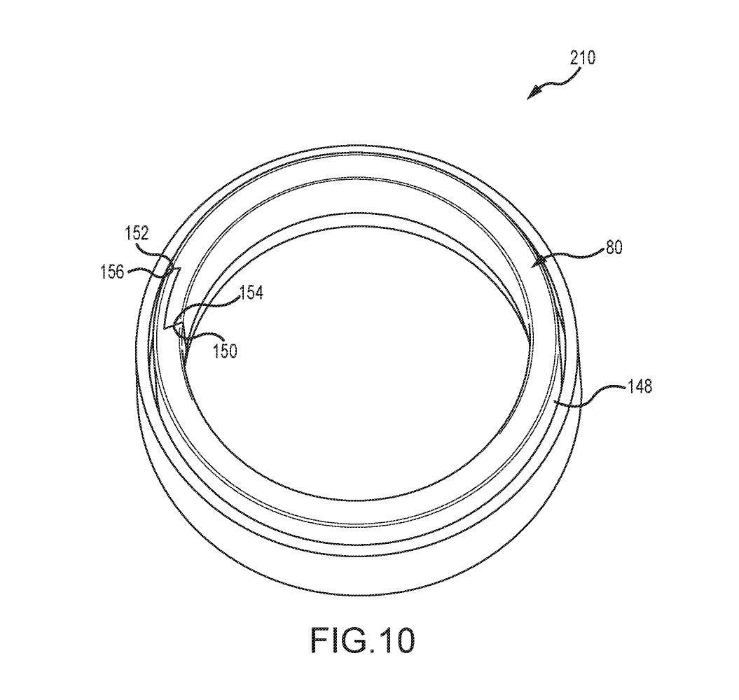

FIG. 10 is a top perspective view of an embodiment of the c-ring 80 arranged within an annular fitting 210. In the illustrated embodiment, the c-ring 80 is fully collapsed. In other words, the inner stop 150 is in contact with the inner edge 154 and the outer stop 152 is in contact with the outer edge 156. Accordingly, the compression of the c-ring 80 is limited to the bore 106, thereby preventing over-collapse of the c-ring 80. Furthermore, in the illustrated embodiment, the annular fitting 210 may be utilized to limit the expansion of the c-ring 80. For example, as the c-ring 80 expands, the circumference 148 will contact the annular fitting 210, thereby blocking further expansion. In this manner, the c-ring 80 may be self-limiting regarding both the expansion and collapse of the c-ring 80.

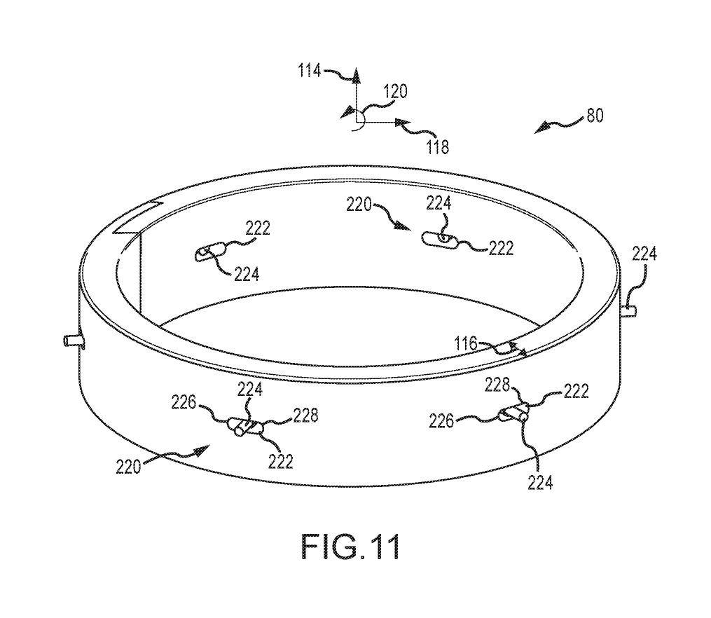

FIG. 11 is a perspective view of an embodiment of the c-ring 80 including axial retention features 220. In certain embodiments, the c-ring 80 may be arranged along a tubular and may be susceptible to axial movement along the longitudinal axis 114. For example, as the seal and hanger assembly 82 is run out of the wellbore 18, the c-ring 80 may slip and slide downward, thereby potentially getting stuck in the wellbore 18. The axial retention features 220 are utilized to rigidly couple the c-ring 80 to a component, such as the tubular, to substantially block axial movement along the longitudinal axis 114 while still enabling expansion and collapse of the c-ring 80. In the illustrated embodiment, the axial retention features 220 are holes 222 extending through the radial thickness 116 of the c-ring 80. As illustrated, fasteners 224 (e.g., screws, bolts, pins, etc.) may be utilized to couple the c-ring 80 in place, thereby blocking axial movement of the c-ring 80.

In operation, several parts, features, and/or processes may act on the c-ring 80, which may snag, twist, or otherwise act on the c-ring 80. For example, in embodiments that include a riser, the inner diameter of the riser may contact the c-ring 80 during operation, installation, or removal. Additionally, the BOP assembly 48 may include cavities, rams, or other equipment that may act on the c-ring 80. Furthermore, fluid velocities, such as from drilling mud or sea water in open water drilling, may also impart forces on the c-ring 80 and lead to snags or twists. Furthermore, the c-ring 80 may snap or otherwise get stuck during retrieval operations.

In the illustrated embodiment, the holes 222 have an elongated shape to enable expansion and collapse of the c-ring 80. For example, in the illustrated embodiment, the holes 222 are oblong or elongated to enable expansion and collapse. That is, the holes 222 include a first side 226 and a second side 228. In the illustrated embodiment, the c-ring 80 is fully collapsed. As the c-ring 80 expands, the first side 226 of the holes 222 will move closer to the fastener 224, which remains substantially stationary. It should be appreciated that, in certain embodiments, the holes 222 may be different shapes. For example, the holes 222 may be substantially round, rectangular, or any other suitable shape that enables both expansion and collapse of the c-ring 80 without imparting significant forces on the fasteners 224. In this manner, axial movement of the c-ring 80 may be substantially prevented, thereby facilitating retrieval of the c-ring 80 from, for example, the wellbore 18.

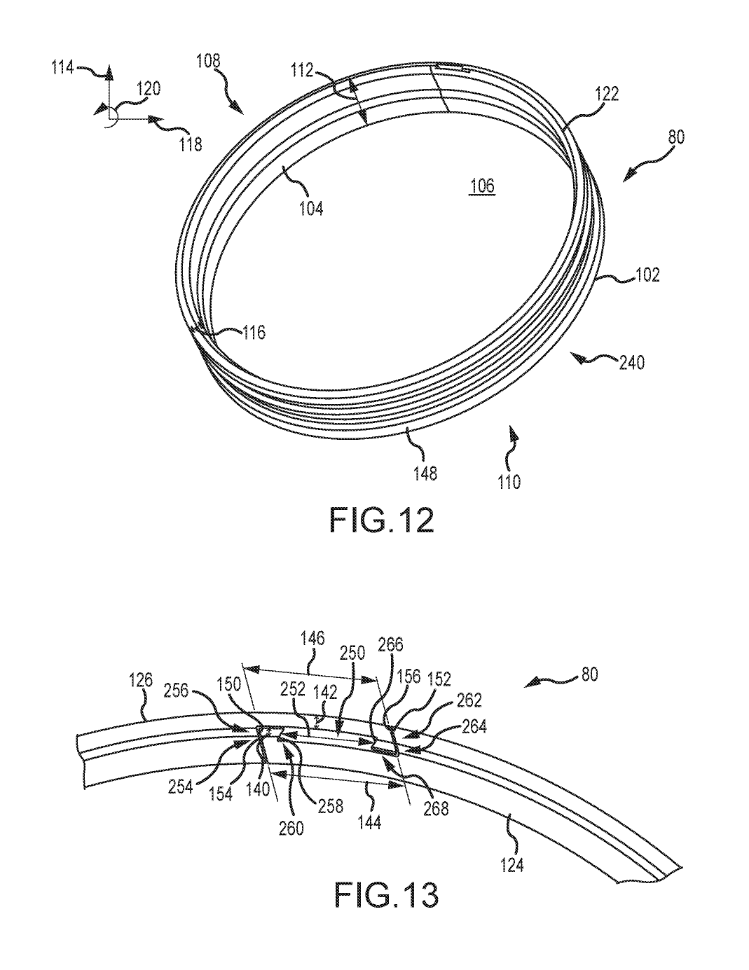

FIG. 12 is a perspective view of an embodiment of the c-ring 80. In the illustrated embodiment, the c-ring 80 includes the body 100 and has an outer diameter 102 and an inner diameter 104. As shown, the c-ring 80 is in the shape of an axial ring having a bore 106 extending through the center and substantially defined by the inner diameter 104. In the illustrated embodiment, the outer diameter 102 includes ridges 240 positioned to extend about the circumference 148 of the c-ring 80. Moreover, the ridges 240 are also arranged on the inner diameter 104 of the c-ring 80. However, it should be appreciated that, in certain embodiments, the outer and inner diameters 102, 104 may be substantially smooth. Moreover, the outer and inner diameters 102, 104 need not be identical. For example, the outer diameter 102 may include the ridges 240 while the inner diameter 104 is smooth. As described above, the c-ring 80 may be formed from rigid materials, such as metals, plastics, or the like. Furthermore, additional resilient components, such as elastomers, seals, crushable gaskets, or the like may be incorporated into the c-ring 80.

In the illustrated embodiment, the c-ring 80 has the axial height 112, relative to the longitudinal axis 114. Moreover, the c-ring 80 includes the radial thickness 116, relative to the radial axis 118. Furthermore, as described above, the substantially annular shape of the c-ring 80 continues about the circumferential axis 120, thereby closing the ends of the c-ring 80. In certain embodiments, as described above, the top 108 and/or bottom 110 of the c-ring 80 may include bevels 122 to facilitate installation and fitting of the c-ring 80 for a given application. As described above, the c-ring 80 may be referred to as self-limiting by limiting the collapse of the c-ring 80, the expansion of the c-ring 80, or both.

FIG. 13 is a partial perspective view of an embodiment of the c-ring 80 illustrating the inner arm 124 and the outer arm 126. In the illustrated embodiment, the c-ring 80 includes the inner arm 124 and the outer arm 126 to block over-expansion and over-collapse, as will be described in detail below. In the illustrated embodiment, the inner arm 24 has the inner arm thickness 140 extending outwardly in the radial direction and the outer arm 142 has the outer arm thickness 142 extending outwardly in the radial direction. In certain embodiments, the inner arm thickness 140 is substantially equal to the outer arm thickness 142. However, in other embodiments, the inner arm thickness 140 may be greater than or less than the outer arm thickness 142. Furthermore, as described above, the inner arm 140 extends circumferentially (e.g., has an arc length) to form the inner arm length 144 and the outer arm 142 extends circumferentially to form the outer arm length 146. The respective circumferential distances of the arm lengths 144, 146 are particularly selected based on the application of the c-ring 80. For example, in the illustrated embodiment, the inner and outer arm lengths 144, 146 are approximately equal to 1/15 of a circumference 148 of the c-ring 80. However, in other embodiments, the inner and/or outer arm lengths 144, 146 may be equal to approximately 1/100 of the circumference 148, approximately 1/50 of the circumference 148, approximately 1/25 of the circumference 148, approximately 1/20 of the circumference 148, approximately 1/10 of the circumference 148, approximately ⅕ of the circumference 148, or any other suitable length. Moreover, the respective inner and outer arm lengths 144, 146 may be sized to fall within ranges of the circumference 148, such as between approximately 1/100 of the circumference 148 and approximately 1/50 of the circumference 148, between approximately 1/25 of the circumference 148 and approximately 1/20 of the circumference 148, between approximately 1/10 of the circumference 148 and approximately ⅕ of the circumference 148, or any other suitable range. In this manner, the c-ring 80 may be machined to accommodate a variety of operating temperatures and pressures, as well as ancillary loads that may act on the c-ring 80, such as mooring laches, sensors, retrieval operations, and the like.

In the illustrated embodiment, a void 250 is formed in the c-ring 80 to facilitate movement of the inner arm 124 and outer arm 126. That is, in the illustrated embodiment, the c-ring 80 is in the fully collapsed position. As a result, the c-ring 80 may expand an amount equal to a void length 252 (e.g., circumferential length, arc length). In other words, the size of the void 250 may be utilized to limit expansion of the c-ring 80. In the illustrated embodiment, the void 250 is formed in the inner arm 124. However, in other embodiments, the void 250 may be partially formed in the inner arm 124 and partially formed in the outer arm 126, or fully formed in the outer arm 126. In the illustrated embodiment, the void 250 extends through the axial height 112 of the c-ring 80.

As illustrated, the void length 252 is formed along at least a portion of c-ring 80. For example, the void length 252 may be equal to approximately 1/100 of the circumference 148, approximately 1/50 of the circumference 148, approximately 1/25 of the circumference 148, approximately 1/20 of the circumference 148, approximately 1/10 of the circumference 148, approximately ⅕ of the circumference 148, or any other suitable length. Moreover, the respective void length 252 may be sized to fall within ranges of the circumference 148, such as between approximately 1/100 of the circumference 148 and approximately 1/50 of the circumference 148, between approximately 1/25 of the circumference 148 and approximately 1/20 of the circumference 148, between approximately 1/10 of the circumference 148 and approximately ⅕ of the circumference 148, or any other suitable range. In this manner, the c-ring 80 may be machined to accommodate a variety of operating temperature and pressures, as well as ancillary loads that may act on the c-ring 80, such as mooring laches, sensors, retrieval operations, and the like. Additionally, as described above, in embodiments where the c-ring 80 is used in one of a variety of other industries other loads, such as rotational forces, fluid flow, and the like may act on the c-ring 80 to drive expansion and collapse.

In the illustrated embodiment, c-ring 80 includes the inner stop 150, the outer stop 152, the inner edge 154, and the outer edge 156. As shown, the inner stop 150 is arranged on the outer arm 126 and is abutted by the inner edge 154 arranged on the inner arm 124. Moreover, the outer stop 152 is on the inner arm 124 and is abutted by the outer edge 156 on the outer arm 156. In this manner, collapse of the c-ring 80 may be controlled because over-collapse is blocked due to the contact with the stops 150, 152. As described above, in certain embodiments, the inner stop 150, the outer stop 152, the inner edge 154, and/or the outer edge 156 include back rakes to facilitate a closer contact between the features.

As shown in FIG. 13, the inner arm 124 includes an inner restricting member 254 having the inner edge 154 on a first end 256 and an inner restricting edge 258 on a second end 260. In the illustrated embodiment, the inner restricting edge 258 is beveled/slanted to facilitate coupling with a corresponding edge on the outer arm 126. For example, the outer arm 126 includes an outer restricting member 262 having the outer edge 156 on a first end 264 and an outer restricting edge 266 on a second end 268. As will be described below, over-expansion of the c-ring 80 is blocked by contact between the inner restricting edge 258 and the outer restricting edge 266.

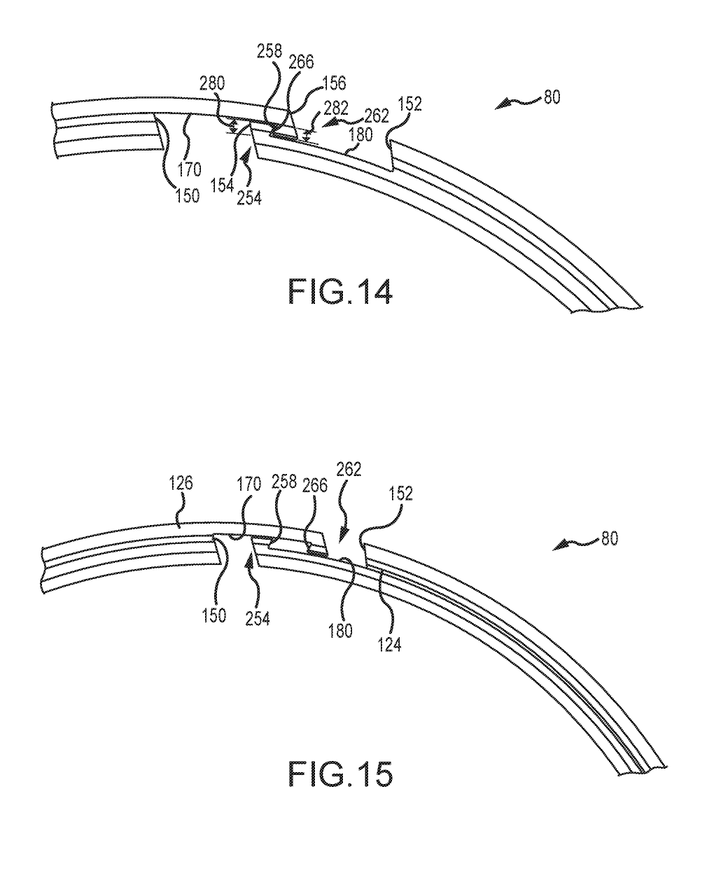

FIG. 14 is a partial perspective view of an embodiment of the c-ring 80 in a fully expanded position. As shown, the inner restricting edge 258 contacts the outer restricting edge 266 to thereby prevent further expansion of the c-ring 80. For example, in certain embodiments the c-ring 80 may expand due to heating. Accordingly, the inner arm 124 and the outer arm 125 will slide over the respective surfaces 170, 180 until further expansion is blocked due to contact between the edges 258, 266. In the illustrated embodiment, an inner restricting thickness 280 is approximately equal to an outer restricting thickness 282. However, it should be appreciated that the respective thicknesses of the restricting members 254, 262 may be particularly selected based on the operating conditions anticipated for the c-ring 80. For example, thicker restricting members 254, 262 may be utilized for high pressure or high temperature applications. In certain embodiments, the respective restricting members 254, 262 may be sized based on expected operating conditions, for example, to accommodate pressures approximately 1.5 times greater than the anticipated operating pressure. However, in certain embodiments, the respective restricting members 254, 262 may be sized to accommodate pressure approximately 1.1 times greater than the anticipated operating pressure, approximately 1.2 times greater than the anticipated operating pressure, approximately 1.3 times greater than the anticipated operating pressure, approximately 1.4 times greater than the anticipated operating pressure, approximately 2.0 times greater than the anticipated operating pressure, or any other suitable pressure range. Furthermore, it should be appreciated that, because the restricting members 254, 262 extend along the axial height 112, that torsional forces that cause twisting will also be resisted due to the frictional contact between the restricting edges 258, 266. That is, as the c-ring 80 undergoes the twisting forces, the restricting edges 258, 266 will bear against one another, thereby providing resistance against the twisting movement. By resisting twisting and deformation due to twisting, the c-ring 80 may be recovered from downhole operations, thereby enabling use for future applications.

FIG. 15 is a partial perspective view of an embodiment of the c-ring 80 in an intermediate expanded position. That is, as the c-ring 80 expands and the inner arm 124 and the outer arm 126 slide over the outer arm surface 170 and the inner arm surface 180 the c-ring 80 may reach expansion without contacting any of the stops 150, 152 or restricting edges 258, 266. Accordingly, the c-ring 80 may continue to operate under normal conditions without utilizing the restricting members 254, 262.

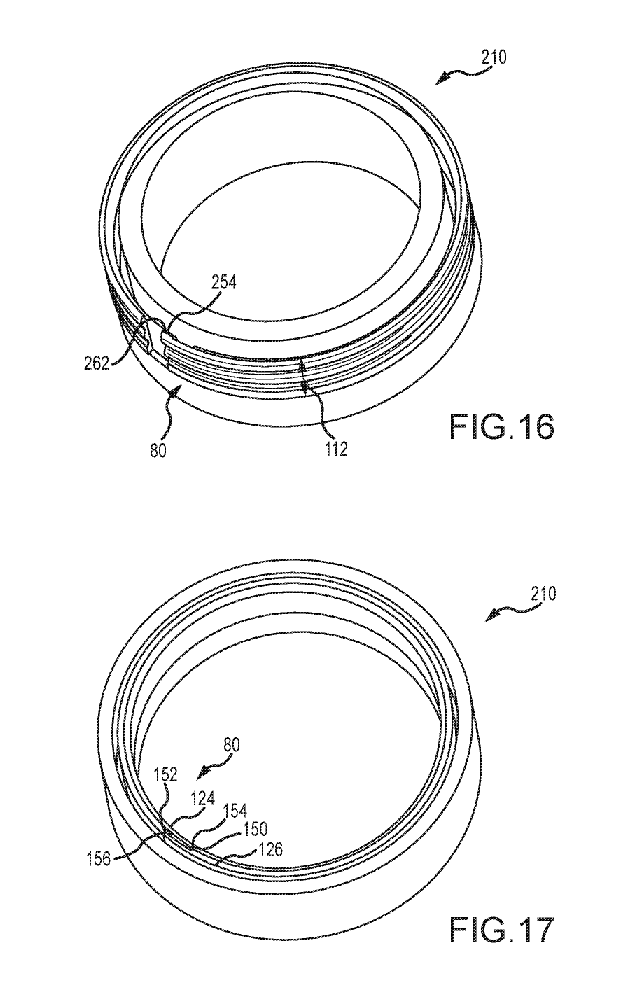

FIG. 16 is a perspective view of an embodiment of the c-ring 80 arranged about the annular fitting 210 in a fully-expanded position. In the illustrated embodiment, the c-ring 80 is in the fully-expanded position such that the respective restricting members 254, 262 are in contact with one another, thereby blocking further expansion of the c-ring 80. As described above, and illustrated in FIG. 16, the restricting members 254, 262 span for the entirety of the axial height 112, in the illustrated embodiment. Accordingly, the radial and/or circumferential forces acting on the c-ring 80 can be accommodated by the surface area and material forming the restricting members 254, 262. In this manner, expansion of the c-ring 80 is limited, thereby reducing the likelihood of over-expansion and twisting of the c-ring 80, which facilitates recovery of the c-ring 80.

FIG. 17 is a perspective view of an embodiment of the c-ring 80 arranged about the annular fitting 210 in a fully-collapsed position. As described above, the c-ring 80 is self-limiting regarding collapse due to the stops 150, 152. That is, as the inner arm 124 and the outer arm 126 slide toward one another on the respective surfaces 170, 180, the inner edge 154 contacts the inner stop 150 and the outer edge 156 contacts the outer stop 152, thereby blocking further collapse of the c-ring 80.

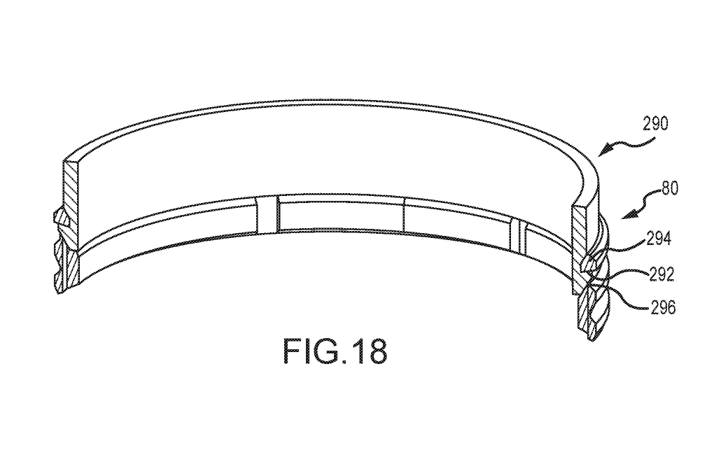

FIG. 18 is a partial cross-sectional perspective view of an embodiment of the c-ring 80 arranged about a fitting 290. In the illustrated embodiment, the fitting 290 includes a ledge 292 which receives a shoulder 294 of the c-ring 80. As a result, axial movement of the c-ring 80 along the longitudinal axis 114 is restricted. For example, upward movement (relative to the plane of the page) of the c-ring 80 is blocked by the ledge 292 and the slanted side 296 below the ledge 292. Moreover, even if the c-ring 80 were to travel along the slanted side 296, as expansion of the c-ring 80 is limited due to the restricting members 254, 262, the c-ring 80 will no longer be able to move upward along the slanted side 296 beyond full expansion of the c-ring 80. Furthermore, downward movement (relative to the plane of the page) of the c-ring 80 is blocked by the ledge 292. Accordingly, axial movement of the c-ring 80 may be controlled.

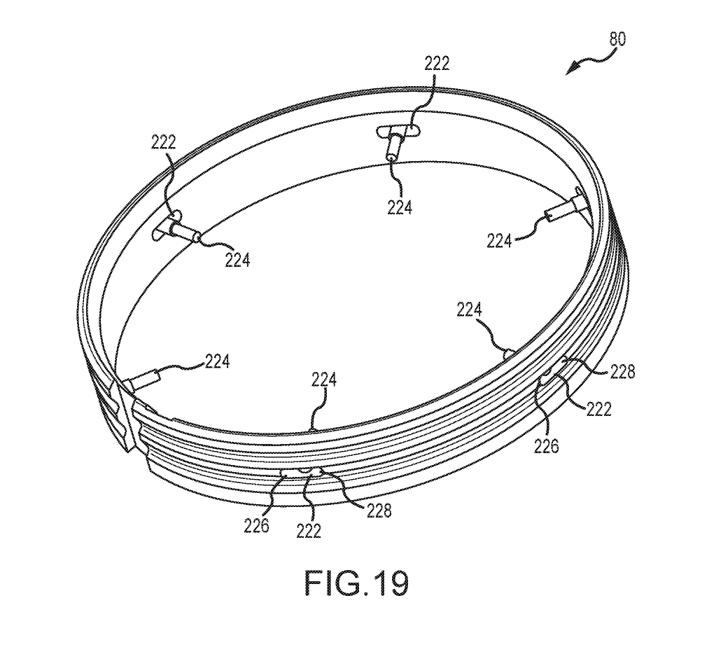

FIG. 19 is a perspective view of an embodiment of the c-ring 80 having the holes 222 to restrict axial movement of the c-ring 80. In the illustrated embodiment, the holes 222 have an elongated shape to enable expansion and collapse of the c-ring 80. For example, in the illustrated embodiment, the holes 222 are oblong or elongated to enable expansion and collapse. Furthermore, the holes 222 include the first side 226 and the second side 228. In the illustrated embodiment, the c-ring 80 is fully expanded. As the c-ring 80 collapses, the second side 228 of the holes 222 will move closer to the fastener 224, which remains substantially stationary. It should be appreciated that, in certain embodiments, the holes 222 may be different shapes. For example, the holes 222 may be substantially round, rectangular, or any other suitable shape that enables both expansion and collapse of the c-ring 80 without imparting significant forces on the fasteners 224. In this manner, axial movement of the c-ring 80 may be substantially prevented, thereby facilitating retrieval of the c-ring 80 from, for example, the wellbore 18.

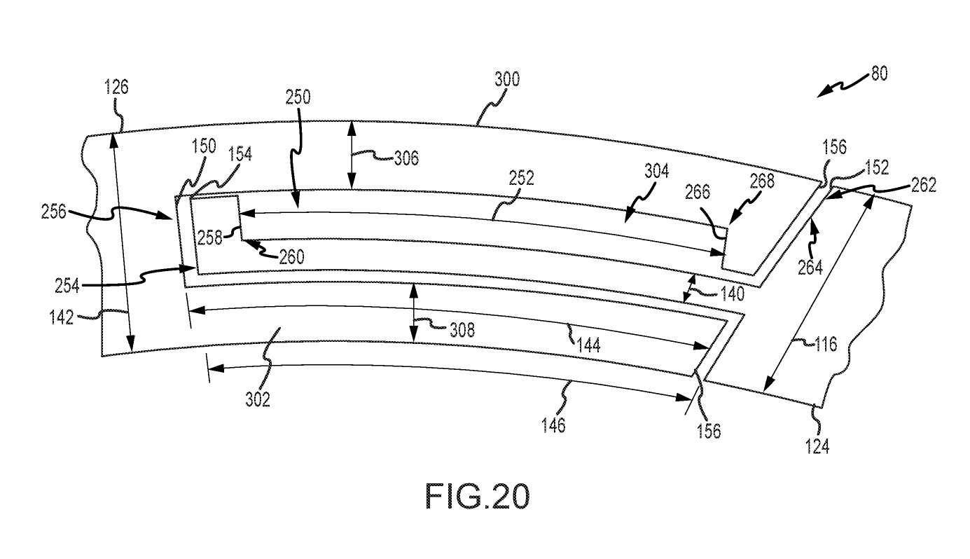

FIG. 20 is a partial perspective view of an embodiment of the c-ring 80 illustrating the inner arm 124 and the outer arm 126. In the illustrated embodiment, the outer arm 126 includes a first arm 300 and a second arm 302. In the illustrated embodiment, the inner arm 124 is positioned between the first arm 300 and the second arm 302. In other words, a cavity 304 is formed between the first arm 300 and the second arm 302, which receives the inner arm 124. Because of the positioning of the inner arm 124 within the cavity 304, torsional forces applied to the c-ring 80 (for example, due to fluid flow along the downhole tool or snags as the c-ring 80 is retrieved) are reacted at two points, as will be described in detail below.

In the illustrated embodiment, the c-ring 80 includes the inner arm 124 and the outer arm 126 to block over-expansion and over-collapse, as will be described in detail below. As described above, the c-ring 80 includes the radial thickness 116, which is formed at least partially by the inner arm thickness 140 and the outer arm thickness 142. In the illustrated embodiment, the outer arm 126 includes the first arm 300 and the second arm 302. As shown, a first arm thickness 306 is substantially equal to a second arm thickness 308. However, it should be appreciated that the first arm thickness 306 may be greater than or less than the second arm thickness 308. Moreover, in embodiments, the inner arm thickness 140 may be equal to, greater than, or less than the first arm thickness 306 and/or the second arm thickness 308.

As described above, the inner arm 124 extends circumferentially (e.g., has an arc length) to form the inner arm length 144 and the outer arm 126 extends circumferentially to form the outer arm length 146. The respective circumferential distances of the arm lengths 144, 146 are particularly selected based on the application of the c-ring 80. For example, in the illustrated embodiment, the inner and outer arm lengths 144, 146 are approximately equal to 1/15 of a circumference 148 of the c-ring 80. However, in other embodiments, the inner and/or outer arm lengths 144, 146 may be equal to approximately 1/100 of the circumference 148, approximately 1/50 of the circumference 148, approximately 1/25 of the circumference 148, approximately 1/20 of the circumference 148, approximately 1/10 of the circumference 148, approximately ⅕ of the circumference 148, or any other suitable length. Moreover, the respective inner and outer arm lengths 144, 146 may be sized to fall within ranges of the circumference 148, such as between approximately 1/100 of the circumference 148 and approximately 1/50 of the circumference 148, between approximately 1/25 of the circumference 148 and approximately 1/20 of the circumference 148, between approximately 1/10 of the circumference 148 and approximately ⅕ of the circumference 148, or any other suitable range. In this manner, the c-ring 80 may be machined to accommodate a variety of operating temperatures and pressures, as well as ancillary loads that may act on the c-ring 80, such as mooring laches, sensors, retrieval operations, and the like.

In the illustrated embodiment, the void 250 is formed in the c-ring 80 to facilitate movement of the inner arm 124 and outer arm 126. That is, in the illustrated embodiment, the c-ring 80 is in the fully collapsed position. As a result, the c-ring 80 may expand an amount equal to the void length 252 (e.g., circumferential length, arc length). In other words, the size of the void 250 may be utilized to limit expansion of the c-ring 80. In the illustrated embodiment, the void 250 is formed in the inner arm 124. However, in other embodiments, the void 250 may be partially formed in the inner arm 124 and partially formed in the outer arm 126, or fully formed in the outer arm 126. In the illustrated embodiment, the void 250 extends through the axial height 112 of the c-ring 80.

As illustrated, the void length 252 is formed along at least a portion of c-ring 80. For example, the void length 252 may be equal to approximately 1/100 of the circumference 148, approximately 1/50 of the circumference 148, approximately 1/25 of the circumference 148, approximately 1/20 of the circumference 148, approximately 1/10 of the circumference 148, approximately ⅕ of the circumference 148, or any other suitable length. Moreover, the respective void length 252 may be sized to fall within ranges of the circumference 148, such as between approximately 1/100 of the circumference 148 and approximately 1/50 of the circumference 148, between approximately 1/25 of the circumference 148 and approximately 1/20 of the circumference 148, between approximately 1/10 of the circumference 148 and approximately ⅕ of the circumference 148, or any other suitable range. In this manner, the c-ring 80 may be machined to accommodate a variety of operating temperature and pressures, as well as ancillary loads that may act on the c-ring 80, such as mooring laches, sensors, retrieval operations, and the like.

In the illustrated embodiment, c-ring 80 includes the inner stop 150, the outer stop 152, the inner edge 154, and the outer edge 156. As shown, the inner stop 150 is arranged on the outer arm 126 and is abutted by the inner edge 154 arranged on the inner arm 124. Moreover, the outer stop 152 is on the inner arm 124 and is abutted by the outer edge 156 on the outer arm 156. In this manner, collapse of the c-ring 80 may be controlled because over-collapse is blocked due to the contact with the stops 150, 152. As described above, in certain embodiments, the inner stop 150, the outer stop 152, the inner edge 154, and/or the outer edge 156 include back rakes to facilitate a closer contact between the features. Furthermore, as shown in FIG. 20, outer stop 152 is split over the first and second arms 300, 302. That is, because the inner arm 124 is positioned within the cavity 304, the inner arm 124 includes outer stops 152 to contact both the first and second arms 300, 302. Furthermore, the outer arm 126 includes the outer edges 156 on both the first and second arms 300, 302.

As shown in FIG. 20, the inner arm 124 includes an inner restricting member 254 having the inner edge 154 on a first end 256 and an inner restricting edge 258 on a second end 260. In the illustrated embodiment, the inner restricting edge 258 is substantially straight. However, in other embodiments, the inner restricting edge 258 may be beveled/slanted to facilitate coupling with a corresponding edge on the outer arm 126. For example, the outer arm 126 includes an outer restricting member 262 having the outer edge 156 on a first end 264 and an outer restricting edge 266 on a second end 268. This restricting member 262 is positioned on the first arm 300, in the illustrated embodiment. As will be described below, over-expansion of the c-ring 80 is blocked by contact between the inner restricting edge 258 and the outer restricting edge 266.

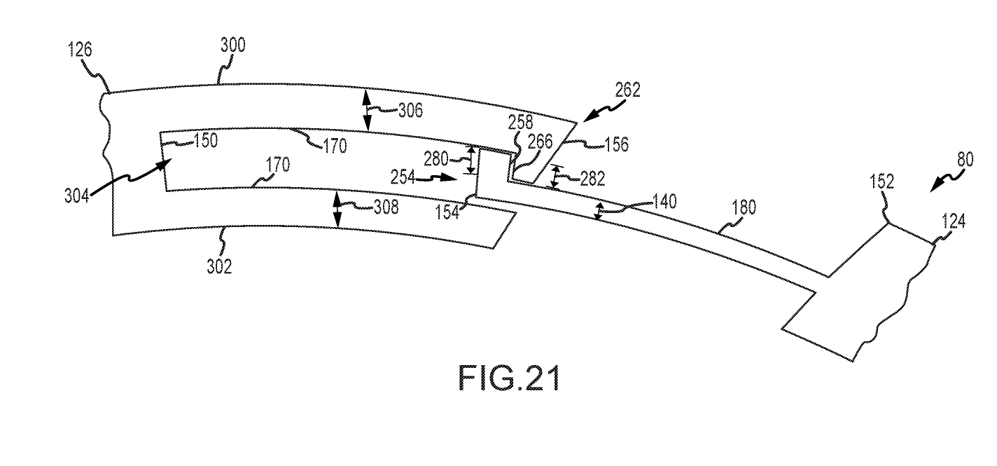

FIG. 21 is a partial perspective view of an embodiment of the c-ring 80 in a fully expanded position. As shown, the inner restricting edge 258 contacts the outer restricting edge 266 to thereby prevent further expansion of the c-ring 80. For example, in certain embodiments the c-ring 80 may expand due to heating. Accordingly, the inner arm 124 and the outer arm 126 will slide over the respective surfaces 170, 180 until further expansion is blocked due to contact between the edges 258, 266. In the illustrated embodiment, the inner restricting thickness 280 is approximately equal to the outer restricting thickness 282. However, it should be appreciated that the respective thicknesses of the restricting members 254, 262 may be particularly selected based on the operating conditions anticipated for the c-ring 80. For example, thicker restricting members 254, 262 may be utilized for high pressure or high temperature applications. In certain embodiments, the respective restricting members 254, 262 may be sized based on expected operating conditions, for example, to accommodate pressures approximately 1.5 times greater than the anticipated operating pressure. However, in certain embodiments, the respective restricting members 254, 262 may be sized to accommodate pressure approximately 1.1 times greater than the anticipated operating pressure, approximately 1.2 times greater than the anticipated operating pressure, approximately 1.3 times greater than the anticipated operating pressure, approximately 1.4 times greater than the anticipated operating pressure, approximately 2.0 times greater than the anticipated operating pressure, or any other suitable pressure range. Furthermore, it should be appreciated that, because the restricting members 254, 262 extend along the axial height 112, that torsional forces that cause twisting will also be resisted due to the frictional contact between the restricting edges 258, 266. That is, as the c-ring 80 undergoes the twisting forces, the restricting edges 258, 266 will bear against one another, thereby providing resistance against the twisting movement. By resisting twisting and deformation due to twisting, the c-ring 80 may be recovered from downhole operations, thereby enabling use for future applications.

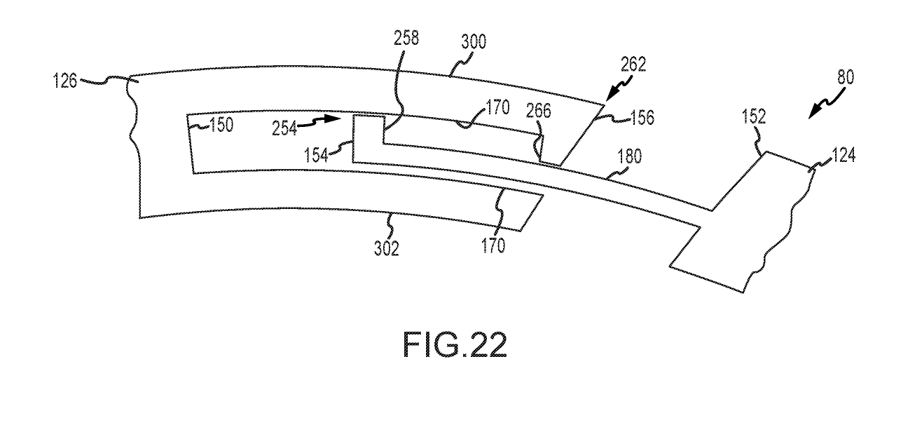

FIG. 22 is a partial perspective view of an embodiment of the c-ring 80 in an intermediate expanded position. That is, as the c-ring 80 expands and the inner arm 124 and the outer arm 126 slide over the outer arm surface 170 and the inner arm surface 180 the c-ring 80 may reach expansion without contacting any of the stops 150, 152 or restricting edges 258, 266. Accordingly, the c-ring 80 may continue to operate under normal conditions without utilizing the restricting members 254, 262.

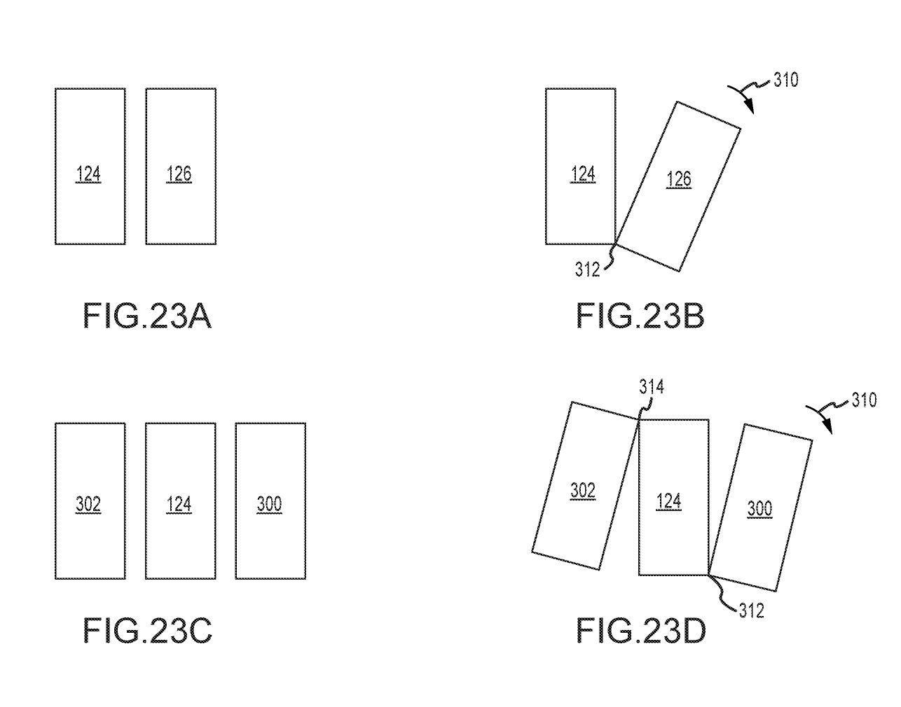

FIG. 23 is a schematic top plan view of embodiments of the c-ring 80. As described above, in certain embodiments, the c-ring 80 may accommodate torsional forces. That is, even if the c-ring 80 is subjected to torsional forces, for example, during retrieval operations, the c-ring 80 will resist the forces, thereby reducing the likelihood the c-ring 80 is deformed to the point where it cannot be retrieved. As shown in FIGS. 23(a) and (23b), the inner arm 124 is positioned proximate the outer arm 126 during normal operations. A torsional force represented by the arrow 310 is applied to the outer arm 126 in FIG. 23(b). The torsional force 310 twists the outer arm 126 and brings the outer arm 126 into contact with the inner arm 124 at a first reaction point 312. Accordingly, twisting of the outer arm 126 is blocked by the inner arm 124, which is positioned against a tubular or other solid structure.

Furthermore, as illustrated in FIGS. 23(c) and 23(d), in certain embodiments, such as the configuration illustrated in FIG. 20, the outer arm 126 includes the first arm 300 and the second arm 302. As shown in FIG. 23(d), as the torsional force 310 is applied, the outer arm 126 twists and moves into contact with the inner arm 124. In the illustrated embodiment, two reaction points 312, 314 are generated due to the twisting. That is, the first arm 300 contacts the inner arm 124 at the first reaction point 312 and the second arm 302 contacts the inner arm 124 at the second reaction point 314. As a result, twisting of the outer arm 126 is blocked at two reaction points instead of one, thereby creating a socketing which resists further twisting. Furthermore, in the embodiments illustrated in FIGS. 23(c) and 23(d), if the first arm 300 were pulled away from the inner arm 124 (e.g., to the right relative to the direction of the page), then the second arm 302 would be drawn toward the inner arm 124, thereby preventing the further pulling of the first arm 300.

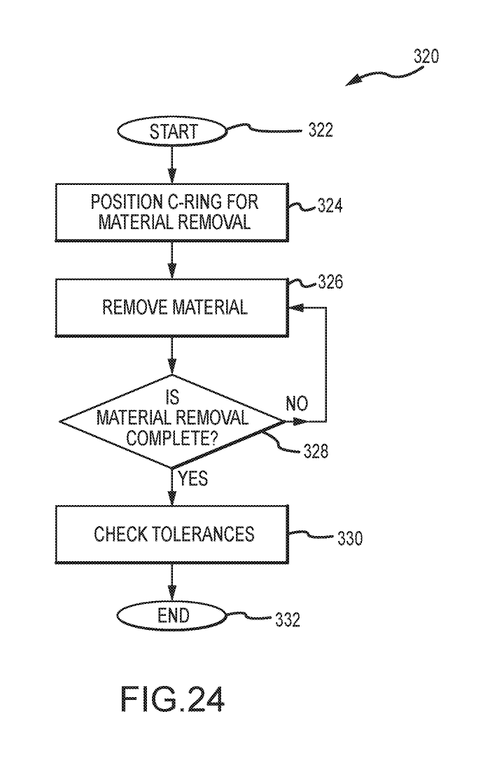

In certain embodiments, the c-ring 80 may be machined from a single, solid forging. For example, electrical discharge machining (EDM) may be utilized to make the unique cuts to enable the self-limiting properties of the c-ring 80. EDM cuts material using electrical discharges (e.g., sparks) between two electrodes and a dielectric liquid to remove material. By utilizing EDM, the c-ring 80 may be formed from very hard metals, such as pre-hardened steel, without the need for heat treatment. Furthermore, EDM enables very precise, complex shapes, to be manufactured in the c-ring 80, which would be difficult or not possible utilizing other methods. FIG. 24 is a flow chart of a method 320 for machining the c-ring 80. The method starts (block 322) and the c-ring 80 is positioned for material removal (block 324). For example, the c-ring 80 may be positioned in an EDM machine for material removal. The EDM machine may have a template or pattern for the c-ring 80 having a desired shaped of the cuts made in the c-ring 80. Next, material is removed from the c-ring 80 (block 326). For example, the void 250 may be formed in the c-ring 80. Thereafter, an operator will check if the material removal is complete (operator 328). For example, the operator may compare the template to the finished c-ring 80 to determine whether additional material removal is needed. If additional material removal is needed, the method returns to block 326. If sufficient material is removed, the method continues and the tolerances of the c-ring 80 are checked (block 330). Thereafter, the method ends (block 332). In this manner, the c-ring 80 may be machined for a solid forging utilizing EDM to enable the small, precise patters for forming the self-limiting c-ring 80. Moreover, in certain embodiments, additional machining and forming methods may be used, such as 3D printing.

As described in detail above the c-ring 80 is self-limiting due to the interaction of the inner arm 124 and the outer arm 126. For example, contact between the inner stop 150 and the inner edge 154, as well as contact between the outer stop 152 and the outer edge 156 prevents over collapse of the c-ring 80. Furthermore, over expansion may be limited by the restricting members 254, 262. For example, the inner restricting edge 258 may contact the outer restricting edge 266, thereby blocking further expansion of the c-ring 80. Furthermore, in certain embodiments, twisting of the c-ring 80 may be reduced or substantially eliminated. For example, the tongue 128 and groove 130 fitting may block twisting of the c-ring 80 by transmitting the torsional forces applied to the c-ring 80 to the edges of the groove 130. Furthermore, the restricting members 254, 262 may bear against one another in response to torsional forces, which would prevent twisting of the c-ring 80. In this manner, the expansion and collapse of the c-ring 80 may be controlled, as well as the twisting of the c-ring 80.

The foregoing disclosure and description of the disclosed embodiments is illustrative and explanatory of the embodiments of the invention. Various changes in the details of the illustrated embodiments can be made within the scope of the appended claims without departing from the true spirit of the disclosure. The embodiments of the present disclosure should only be limited by the following claims and their legal equivalents.

1. An apparatus for forming a tubular fitting, comprising:
an annular body having an axial height and radial thickness;
an inner arm forming at least a portion of the annular body, the inner arm positioned at a first end of the annular body with an inner arm thickness that is less than the radial thickness;
an outer arm forming at least a portion of the annular body, the outer arm positioned at a second end of the annular body with an outer arm thickness that is less than the radial thickness; and
one or more self-limiting features that control movement of the inner arm and the outer arm relative to one another.

2. The apparatus of claim 1, wherein the one or more self-limiting features comprise:
an inner edge arranged on an end of the inner arm;
an inner stop arranged on the annular body and radially inward from the outer arm;
wherein the annular body collapses as the inner edge is moved toward the inner stop by one or more forces acting on the annular body and when the inner edge contacts the inner stop further collapse of the annular body is blocked.

3. The apparatus of claim 1, wherein the one or more self-limiting features comprise:
an outer edge arranged on an end of the second arm;
an outer stop arranged on the annular body and radially outward from the inner arm;
wherein the annular body expands as outer edge is moved toward the outer stop by one or more forces acting on the annular body and when the outer edge contacts the outer stop further expansion of the annular body is blocked.

4. The apparatus of claim 1, further comprising:
a tongue extending radially inwardly toward a longitudinal axis of the annular body from the outer arm; and
a groove formed in the inner arm, the groove receiving the tongue to substantially block separation of the inner arm from the outer arm.

5. The apparatus of claim 1, further comprising:
a tongue extending radially outwardly away from a longitudinal axis of the annular body from the inner arm; and
a groove formed in the outer arm, the groove receiving the tongue to substantially block separation of the inner arm from the outer arm.

6. The apparatus of claim 1, wherein the one or more self-limiting features comprise:
a first restricting member formed on the inner arm, the first restricting member including an inner stop on a first side and an inner restricting edge on a second side; and
a second restricting member formed on the outer arm, the second restricting member including an outer stop on a first end and an outer restricting edge on a second end.

7. The apparatus of claim 6, further comprising a void extending through the annular height of the annular body, the void defining an expansion distance for the annular body.

8. The apparatus of claim 1, further comprising one or more holes extending through the radial thickness of the annular body to receive one or more fasteners to block axial movement of the annular body.

9. The apparatus of claim 1, wherein the outer arm comprises:
a first arm; and
a second arm, the first arm being positioned radially further from the longitudinal axis than the second arm and the inner arm being arranged between the first arm and the second arm.

10. A system for forming a coupling between tubulars, comprising:
a tubular; and
a self-limiting c-ring arranged circumferentially about the tubular, the c-ring comprising:
an inner arm forming at least a portion of an annular body of the c-ring, the inner arm being positioned at a first end of the annular body;
an outer arm forming at least a portion of the annular body, the outer arm being positioned at a second end of the annular body and overlapping the inner arm when the c-ring is in a fully collapsed position; and
one or more self-limiting features arranged on the annular body to control the movement of the inner arm and the outer arm relative to one another.

11. The system of claim 10, wherein the one or more self-limiting features comprise:
an inner edge arranged on an end of the inner arm; and
an inner stop arranged radially inward from the outer arm on the annular body;
wherein the inner edge is moved toward the inner stop and compresses the tubular by one or more forces acting on the c-ring and when the inner edge contacts the inner stop further compressive movement of the inner arm is blocked.

12. The system of claim 10, further comprising:
a tongue extending radially inwardly from a surface of the outer arm; and
a groove formed in the inner arm, the groove receiving the tongue to substantially block twisting of the c-ring.

13. The system of claim 10, further comprising:
a first restricting member formed on the inner arm and extending radially outward from a longitudinal axis of the c-ring, the first restricting member including an inner stop on a first side and an inner restricting edge on a second side; and
a second restricting member formed on the outer arm and extending radially inward toward the longitudinal axis, the second restricting member including an outer stop on a first end and an outer restricting edge on a second end;
wherein expansion of the c-ring is blocked then the inner restricting edge is moved into contact with the outer restricting edge.

14. The system of claim 10, further comprising one or more holes extending through a radial thickness of the c-ring, the holes receiving on or more fasteners to couple the c-ring to the tubular and block axial movement of the c-ring along a longitudinal axis of the tubular.

15. The system of claim 10, further comprising a void extending through an annular body of the c-ring, the void defining an expansion distance for the c-ring.

16. The system of claim 10, wherein the outer arm comprises:
a first arm; and
a second arm, the first arm being positioned radially further from the longitudinal axis than the second arm and the inner arm being arranged between the first arm and the second arm.

17. A method comprising:
(a) positioning a c-ring in an electrical discharge machine, the c-ring having an axial height and radial thickness;
(b) removing material from the c-ring such that one or more cuts extends through the axial height of the c-ring; and
(c) removing the c-ring from the electrical discharge machine after the one or more cuts are completed.

18. The method of claim 17, further comprising (d) evaluating whether sufficient material has been removed after (b) by comparing the one or more cuts with a template, the material removal from the c-ring extending through the axial height of the c-ring to enable expansion and collapse of the c-ring.

19. The method of claim 17, further comprising (e) checking tolerances of the c-ring after step (b).

20. The method of claim 17, wherein step (b) is done based on a template, the template comprising the one or more cuts forming an inner arm and outer arm in the c-ring.
